(19) United States
(12) Patent Application Publication
(10) Pub. No.: US 2012/0138114 A1
(43) Pub. Date: Jun. 7, 2012

(54) Retractable Enclosure Assembly and Method of Using the Same

(76) Inventor: Joshua Landsberger, Elk Grove Village, IL (US)

(21) Appl. No.: 12/960,893

(22) Filed: Dec. 6, 2010

(51) Int. Cl. E04H 15/58; B23P 11/00; E04H 15/56

(52) U.S. Cl. 135/116; 29/428

(57) ABSTRACT

The present invention provides a retractable enclosure assembly and method of using the same. The assembly includes at least a base, a housing mounted to the base and a cover secured inside the housing. The assembly also includes a means mounted on the housing to engage the cover into the housing and to disengage the cover from the housing such that the disengagement of the cover functions to enclose the object and the engagement of the coyer functions to uncover the object.

### BACKGROUND OF THE INVENTION

1. Field of the Invention

The present invention generally relates to protective covers used for objects, and in particular, to a retractable enclosure assembly that is used to cover/uncover any object that is not in use.

2. Description of Related Art

Currently, many enclosures are available in the market to cover for both indoor and outdoor equipment and other objects such as barbecue grills, furniture, art work, fireplace etc. Conventional canvas covers have many deficiencies. Some of them include, but not limited to, unattractive, can be easily blown away with high winds, and must be stored when not in use. Moreover, the removal, folding, and storage of conventional canvas covers can be time-consuming and inconvenient exercise. Other enclosures in the market include wooden covers. However, these wooden covers are very heavy, cumbersome and often unattractive. Similar to the canvas cover, the wooden covers also require space when not in use.

Furthermore, many retractable systems exist today that provide for enclosures of the objects. Some of them include projection screens, trade show display banners, vehicle window sun shades, and retractable security baby and dog gates. However, these are limited in width to the size of the enclosure, take up too much space and are often awkward and unsightly.

Thus, there is a need in the art to provide a new retractable enclosure which is flexible, extendible, easily foldable, takes up less space, and allows for the open size to be at least double or more of the enclosure.

### SUMMARY OF THE INVENTION

The present invention relates to a retractable enclosure assembly and method of using the same. The assembly provides an enclosure for any object using a concept of a retractable projection screen or a tradeshow banner that occupies less space, can easily and rapidly cover or uncover any object and further allows for more flexible applications.

### BRIEF DESCRIPTION OF THE DRAWINGS

The present invention will be more readily understood from the detailed description of exemplary embodiments presented below considered in conjunction with the attached drawings, of which:

FIG. 1A is a perspective view of an exemplary embodiment of a retractable enclosure assembly in a closed position in accordance with the present invention.

FIG. 1B is a perspective view of the retractable enclosure assembly in an open position in accordance with the present invention.

FIG. 2 illustrates the enclosure assembly of FIG. 1 positioned with respect to an object in accordance with one embodiment of the present invention.

FIG. 2A illustrates the enclosure assembly of FIG. 1 positioned with respect to an object in accordance with another embodiment of the present invention.

FIG. 2B illustrates the enclosure assembly of FIG. 1 positioned with respect to an object in accordance with further embodiment of the present invention.

### DETAILED DESCRIPTION OF THE INVENTION

The present invention relates to a retractable enclosure assembly and method of using the same to allow an operator to easily cover and uncover objects but not limited to barbecue grills, cars, furniture or any object that requires protection from other elements.

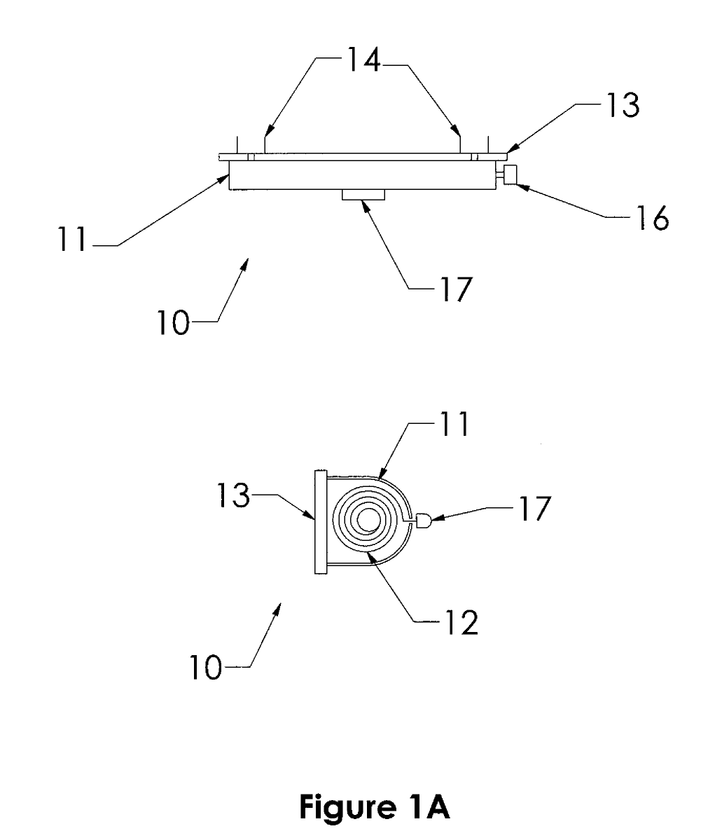

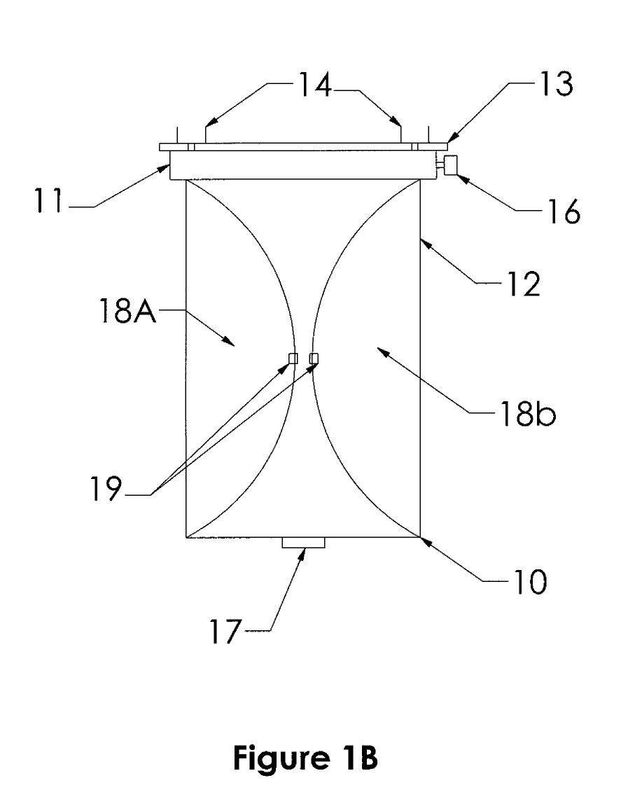

FIGS. 1A and 1B depicts an exemplary retractable enclosure assembly 10 according to an embodiment of the present invention. The enclosure assembly 10 includes a housing 11 and a cover 12 which may be in a folded position inside the housing 11 as shown in FIG. 1A or in a pulled down open position as shown in FIG. 1B. The assembly includes a base 13 for supporting the housing 11 with the cover 12 such that the housing 11 securely rests on the base 13. The base 13 may be made of a weather resistant material, i.e. resistant from heat, rain, cold or any other weather related events. The assembly 10 also includes a clamp or a screw 14 mounted onto the base 13. The screw 14 functions to couple the assembly 10 to an object (not shown), preferably rear of the object. As shown in FIGS. 1A and 1B, the assembly 10 further includes a means 16 coupled to the housing 11, which is utilized to engage and disengage the cover 12 from the housing 11. This means 16 may include manual device such as manual crank gears with a release button for winding cover 12 into enclosure as shown in FIG. 1A and to disengage gearing upon opening of the cover 12 as shown in FIG. 1B. Alternatively, the means 16 may include a motorized device to automatically engage and disengage the cover 12 from the housing 11. The enclosure assembly 10 further includes at least one handle 17, preferably placed on the center of the cover 12 to assist in engaging and disengaging the cover 12 from the housing as will be described in greater detail below. The cover 12 is shaped preferably in a rectangular position similar to a projection screen or a tradeshow banner as shown in FIGS. 1A and 1B. Furthermore, the cover 12 is preferably comprised of a UV protective urethane-coated polyester material. Alternative materials, such has nylon or other materials may be used which may provide for suitable weather protection. In a preferred embodiment, the enclosure assembly 10 further includes at least two flaps 18a and 18b folded in and secured to a center of the cover 12 via a securing means 19 as shown in FIG. 1B. Such securing means 19 may preferably include, but not limited to a velcro, or a snap or a magnet. It is noted that the flaps 18a and 18b are made of a very thin parachute material such as weaved nylon, Kevlar, silk etc.

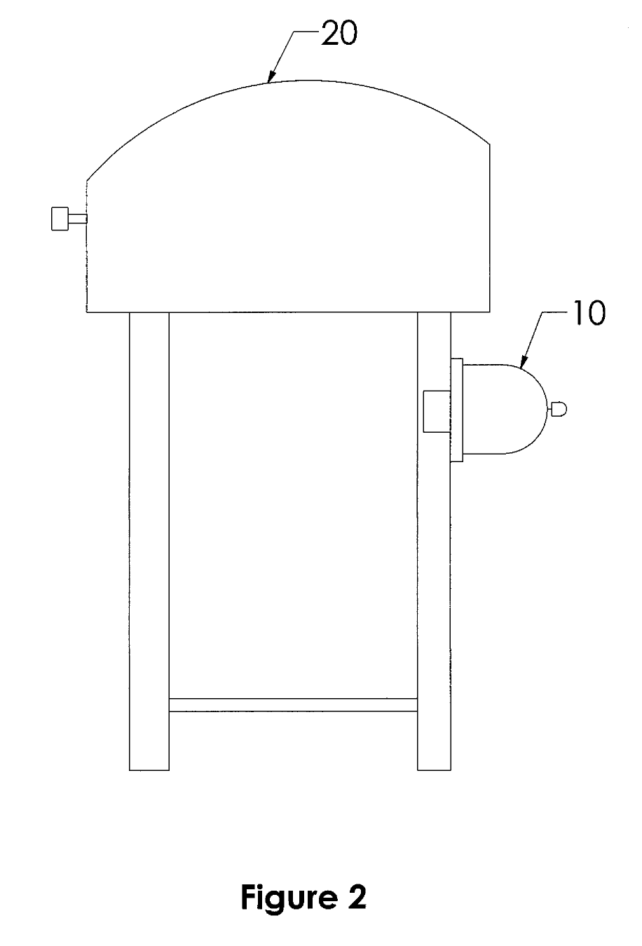

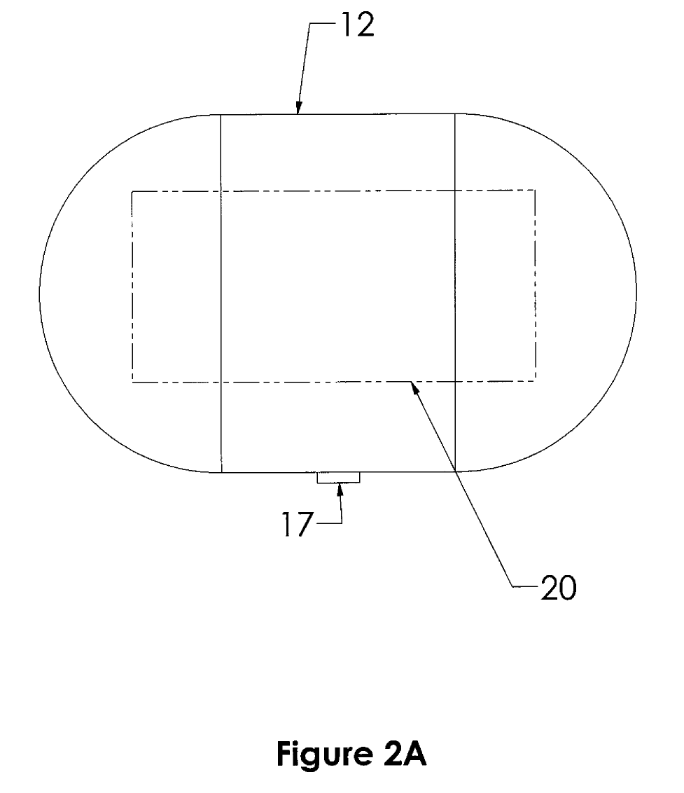

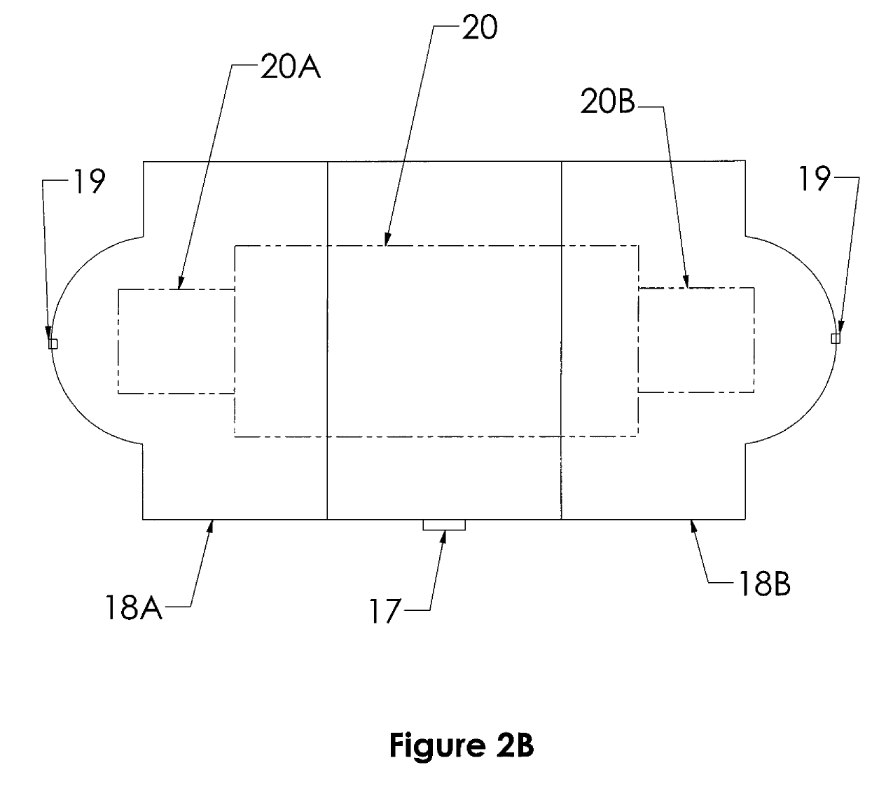

FIGS. 2, 2A and 2B illustrate the enclosure assembly 10 positioned with respect to an object 20. For purpose of this invention, the object 20 illustrated is shaped similar to a typical barbecue grill; however, one skilled in the art would appreciate that other objects may also benefit from the assembly 10.

FIG. 2 illustrates the enclosure assembly 10 mounted preferably on the side of the object 20 through a clamp or a screw 14. FIG. 2A illustrates the enclosure assembly 10 securely covering the object 20. The handle 17 is used by an operator to pull out or disengage the cover 12 from the housing 11 via the means 16 and further fully extend the cover 12 to lie on top of the grill 20. Once fully extended, the cover 12 is completely in an open position and securely rests on the grill 20 as shown in FIG. 2A. Moreover, the front of the cover 12 may preferably remain placed in this position, completely covering the grill 20, by securing the handle 17 into a hook/clamp (not shown) provided on the grill 20. Such hook/clamp on the grill may also function as a hook for grill tools when the assembly 10 is removed the grill 20.

FIG. 2B illustrates the enclosure assembly 10 for further covering the object 20 according to an optional embodiment of the present invention. As shown in FIG. 2B, upon unfolding of the flaps 18a and 18b, the flaps 18a and 18b will pull out similarly in a butterfly position and spread over the left and right side of the grill 20. These flaps 18a and 18b typically spread out to cover a left side 20a (preferably including a shelf) and right side 20b (preferably including a burner) respectively of the grill 20. It is noted that the edges of the flaps 18a and 18b are preferably made of flexible elastic material and will stretch over the sides of the grill 20 and stay in place due to the elastic material. Alternatively, fabric hooks (not shown) can be placed on underside of the left and right of the cover 12 as shown in FIG. 2B to fit tightly onto the sides 20a and 20b of the grill 20.

Furthermore, in order to uncover the object 20, an operator would simply unhook the handle 16 from each side and bring the side flaps 18a and 18b back into the center of the cover 12 and secure it in a folded position as shown in FIG. 2A. Then, the operator would either manually or automatically utilize the means 16 which pulls the cover 12 to engage right back into the housing 11.

Although various embodiments that incorporate the teachings of the present invention have been shown and described in detail herein, those skilled in the art can readily devise many other varied embodiments that still incorporate these teachings without departing from the spirit and the scope of the invention.

1. A retractable enclosure assembly for an object, said assembly comprising:
a base;
a housing mounted to the base;
a cover secured inside the housing;
a means mounted on the housing to engage the cover into the housing and to disengage the cover from the housing, wherein said disengage of the cover functions to enclose the object and engage of the cover functions to uncover the object;
at least one handle coupled to the cover to assist said engage and disengage of the cover.

2. The assembly of claim 1 wherein said means comprise manual device.

3. The assembly of claim 1 wherein said means comprise automatic device.

4. The assembly of claim 1 further comprising at least two flaps folded and secured to a center of the cover.

5. The assembly of claim 4 wherein said flaps are secured via one of a Velcro, snap or a magnet.

6. The assembly of claim 4 wherein said flaps are unfolded from the center of the cover upon disengaging of the cover from the housing to enclose said object.

7. The assembly of claim 1 wherein said handle is secured to the object upon said disengage of the cover from the housing.

8. The assembly of claim 1 wherein said handle is released from the object upon said engage of the cover into the housing.

9. The assembly of claim 1 wherein said housing is mounted on the rear of the object.

10. A method for using a retractable enclosure assembly on an object, said method comprising:
placing said assembly onto rear of the object, said assembly comprising at least a base, a housing mounted onto the base and a cover secured inside the housing;
disengaging the cover from the housing to enclose the cover from said rear onto top of the object onto the front of the object; and
releasing the cover from the front to the top to the rear of the object to engage said cover into the housing.

11. The method of claim 10 wherein said assembly further comprising a handle mounted onto the cover to assist in said disengaging and engaging of the cover.

12. The method of claim 11 further comprising securing said handle to the object upon disengaging of the cover from the housing.

13. The method of claim 10 wherein said housing further comprises at least two flaps folded and secured to a center of the cover;

14. The method of claim 13 further comprising unfolding said flaps to enclose said cover onto each side of the object.

15. The method of claim 13 further comprising release the cover from said each side of the object.
